(19) United States
(12) Patent Application Publication
(10) Pub. No.: US 2005/0101886 A1
(43) Pub. Date: May 12, 2005

(54) Method for cosmetic operation

(76) Inventors: Kazunori Shimagami, Tokyo (JP); Masako Furuyama, Chosei-shi (JP); Nariko Hagiwara, Yokohama-shi (JP)

Correspondence Address: HOGAN & HARTSON L.L.P., 500 S. GRAND AVENUE, SUITE 1900, LOS ANGELES, CA, 90071-2611, US

(21) Appl. No.: 10/111,663

(22) PCT Filed: Jul. 23, 2001
(86) PCT No.: PCT/JP01/06359

(30) Foreign Application Priority Data
Mar. 27, 2001 (JP) 2001-90244

(51) Int. Cl. A61H 1/00

(52) U.S. Cl. 601/1

(57) ABSTRACT

A beauty treatment method comprises: performing a beauty treatment on the face of a client, wherein the beauty treatment includes performing a first massage process; and performing a relaxing massage on at least one body part selected from the group consisting of the head, the neck, the shoulder and the chest of the client, wherein the relaxing massage includes performing a second massage process, wherein the first massage process and the second massage process differ.

### BACKGROUND OF THE INVENTION

1. Field of the Invention

This invention relates to a beauty treatment method carried out by estheticians, etc. for clients.

2. Brief Description of the Background Art

Various massage techniques for beauty have been employed in esthetic salons, esthetic corners in cosmetic shops, etc. Among all, facial massage techniques for a facial treatment have been employed most frequently. Major examples of these facial massage techniques include massage for promoting the blood flow or smoothening the lymph flow and massage on muscles for relieving sags and wrinkles of the skin.

However, it has been understood in recent years that, to enhance beauty effects on the face, not only massage on the face should be carried out, but also manipulations for providing mental relaxing should be carried out to smoothen the blood flow and the lymph flow from the heart toward the face. Although attempts have been made to add novel massage methods for achieving these effects to the conventional facial massage techniques, none of such attempts has been put into practical use hitherto.

### SUMMARY OF THE INVENTION

The invention has been made under these circumstances, and an object of the invention is to provide completely novel beauty treatment method comprising a combination of a beauty treatment on the face with a relaxing massage performed with a movement completely different from the above-described beauty treatment on the face, whereby excellent beauty effects which cannot be achieved by the conventional methods, can be established.

To achieve the object as described above, a first gist of the invention resides in a beauty treatment method comprising:
performing a beauty treatment on the face of a client, wherein the beauty treatment includes performing a first massage process; and
performing a relaxing massage on at least one body part selected from the group consisting of the head, the neck, the shoulder and the chest of the client, wherein the relaxing massage includes performing a second massage process,
wherein the first massage process and the second massage process differ.

A second gist of the invention resides in the beauty treatment method as described above, wherein the relaxing massage further includes applying a body powder to the part of body of from the neck to the chest of the client.

A third gist of the invention resides in the beauty treatment method as described above, wherein at least one of the first massage process and the second massage process is performed using a body part of a person performing the treatment.

A fourth gist of the invention resides in the beauty treatment method as described above, wherein the body part of a person performing the treatment includes at least one of hands.

Among these beauty treatment methods, a fifth gist of the invention resides in the beauty treatment method as described above, wherein the second massage process includes performing at least two treatments selected from the group consisting of treatments (1) to (17):
(1) a first light rubbing treatment which is performed with the whole of one palm, alternatively in the right and left of the client, on the following parts of body of the client: from back of one earlobe to back of the other earlobe via a lower part of the chin; then from the back of the other earlobe to one shoulder via the shoulder muscle below the back of the other earlobe; then from the one shoulder to the other shoulder via the chest; and finally from the other shoulder to the back of the one earlobe via the shoulder muscle above the other shoulder, wherein the shoulders are lightly rubbed as if wrapping each of the shoulders;
(2) a second light rubbing treatment which is performed with the whole of both palms, simultaneously in the right and left of the client, on the parts of body of from the back of the earlobes to the sides of neck of the client, moving the whole of both palms outwardly in a circular movement;
(3) a first rubbing treatment wherein the parts of body of from the back of the neck to the ends of the shoulders of the client is rubbed up and down with the fingertips of both hands, simultaneously in the right and left of the client;
(4) a first spiral strokes treatment, wherein the pectoral muscles of the client are spirally stroked with the fingertips of both hands, simultaneously in the right and left of the client, while moving outward from the center of the chest;
(5) a third light rubbing treatment, wherein the parts on the ribs of the client are lightly rubbed with thumbs of both hands, simultaneously in the right and left of the client, while moving outward from the center of the chest;
(6) a first shiatsu treatment, wherein the parts of body between ribs of the client are applied pressure with thumbs of both hands, simultaneously in the right and left of the client, while moving outward from the center of the chest;
(7) a second shiatsu treatment, wherein the bases of the neck, the center of the shoulders and the ends of the shoulders of the client, in this order, are applied pressure with thumbs of both hands, simultaneously in the right and left of the client;
(8) a second rubbing treatment, wherein the sides of the neck of the client are rubbed up and down with both palms, simultaneously in the right and left of the client;
(9) a second spiral strokes treatment, wherein the head of the client is supported with one palm and a muscle in the back of the neck of the client is spirally stroked with the other hand while moving the other hand upward, alternatively in the right and left of the client;
(10) a pressing treatment, wherein both hands are: put under the arm bases of the client; extended toward the bases of the neck of the client while lifting up the upper part of scapulas of the client; and moved along the nape of the client, and then press the parts of body of from the neck to the back of the head of the client while turning the wrists crossed together;
(11) a vibrating treatment, wherein both hands are placed near the hairline of the client and the neck of the client is vibrated with the both hands while slightly pulling the neck of the client toward;
(12) a stretching treatment, wherein the head of the client is placed on one palm, and the shoulder of the client on which the fingers of the palm are placed is pressed with the other hand so that the shoulder muscle of the client is stretched in horizontal direction, alternatively in the right and left of the client;
(13) a fourth light rubbing treatment, wherein both thumbs are placed on the forehead of the client and the parts above the eyes of the client are lightly rubbed with four fingers of each hand, simultaneously in the right and left of the client, while extending the four fingers outward from the center of the face of the client;
(14) a third shiatsu treatment, wherein the inner tips of the eyebrows, center of the eyebrows and the temples of the client are applied pressure in this order with both thumbs simultaneously in the right and left of the client;
(15) a fourth shiatsu treatment, wherein the fingertips of both hands are moved while applying pressure from the forehead to the back of the head of the client, simultaneously in the right and left of the client;
(16) a tapping treatment, wherein the top of the head of the client is continuously tapped with both hands; and
(17) a pressing and vibrating treatment, wherein the parts of from the temples to the inner corners of the eyes of the client are covered with both palms, and are pressed and vibrated simultaneously in the right and left of the client.

### BRIEF EXPLANATION OF THE DRAWINGS

FIG. 1 illustrates a pamphlet to be used in an embodiment of the invention.

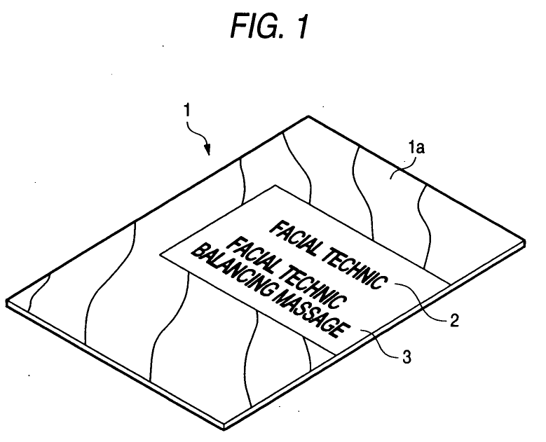

FIG. 2 illustrates a part of the pamphlet as described above.

FIG. 3 illustrates a part of the pamphlet as described above.

FIG. 4 illustrates a part of the pamphlet as described above.

FIG. 5 illustrates a part of the pamphlet as described above.

FIG. 6 illustrates a part of the pamphlet as described above.

FIG. 7 illustrates a part of the pamphlet as described above.

FIG. 8 illustrates a part of the pamphlet as described above.

FIG. 9 illustrates a part of the pamphlet as described above.

FIG. 10 illustrates a part of the pamphlet as described above.

FIG. 11 illustrates a part of the pamphlet as described above.

FIG. 12 illustrates a part of the pamphlet as described above.

FIG. 13 illustrates a part of the pamphlet as described above.

FIG. 14 illustrates a part of the pamphlet as described above.

### DETAILED EXPLANATION OF THE INVENTION

The term “light rubbing” as used in the invention means a hand technique of lightly stroking and rubbing the skin surface. It is a fundamental hand technique for pleasantly stimulating the skin and relaxing a client. The term “vibration” means a hand technique of lightly, delicately and rhythmically vibrating the skin. It is also a fundamental hand technique for pleasantly stimulating the skin and relaxing a client. The term “spiral strokes” means a hand technique of rubbing and spirally stroking the skin so as to stimulate not only the skin but also muscles, thereby promoting the metabolism of tissues and accelerating the blood flow.

Now, a mode for carrying out the invention will be described.

The invention relates to beauty treatment methods that are performed by estheticians, etc. for clients in accordance with, for example, a pamphlet 1 summarizing the contents of the beauty treatments. Now, the contents of this pamphlet 1 will be described below.

The front cover 1a of this pamphlet 1 has a title 2: “Facial Technic” and a subtitle 3: “Facial Technic/Balancing Massage” at the center. The above term “balancing massage” means the beauty treatment on the face employed in this example.

After turning over the front cover 1a, the first several pages indicate some fundamental techniques in the preparatory stage (for example, how to put a towel and how to put a turban) with illustrations. Titles of these pages are respectively as follows.
(1) How to put a towel.
(2) How to put a turban.
(3) How to cleanse point makeup.
(4) How to spread a cleanser.
(5) How to hold a wiping sponge.
(6) How to use a wiping sponge.
(7) How to spread massaging oil.

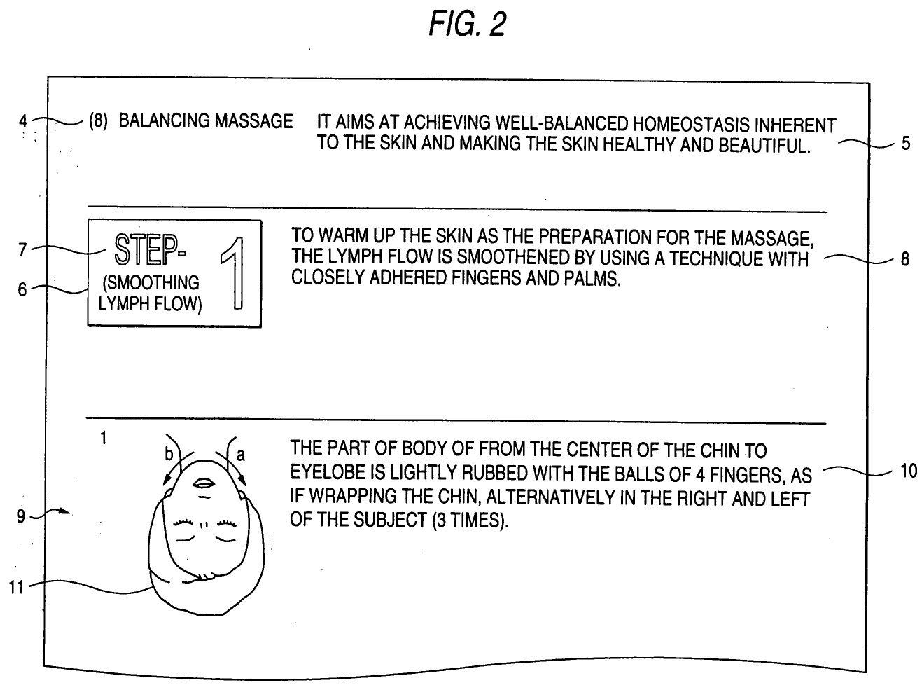

The subsequent several pages indicate the “balancing massage” (i.e., the beauty treatments on the face) with illustrations as the massage process proceeds. As FIG. 2 shows, the first page has a title 4: “(8) Balancing Massage” in the upper column, together with an instruction 5 showing the purpose of the massage: “It aims at achieving well-balanced homeostasis inherent to the skin and making the skin healthy and beautiful.” given in the right.

In the lower column, a title 7: “STEP-1 (Smoothening lymph flow.)” is given in a square frame 6 in the left. Further, an instruction 8 of this step: “To warm up the skin as the preparation for the massage, the lymph flow is smoothened by using a technique with closely adhered fingers and palms.” is given in the right.

In 7 columns from the further lower column of this page to the next page, 7 kinds of treatments for smoothening the lymph flow are provided with illustrations. In 9 of the column 1 (FIG. 2 (1)), for example, an instruction 10 of the treatment: “The part of body of from the center of the chin to back of the earlobe is lightly rubbed with the 4 fingers, as if wrapping the chin, alternatively in the right and left of the client (3 times).” In an illustration 11 of a woman's face provided in the left, the movements of the fingers are shown by arrows (a) and (b). Description on the treatments of the second column and thereafter is omitted herein.

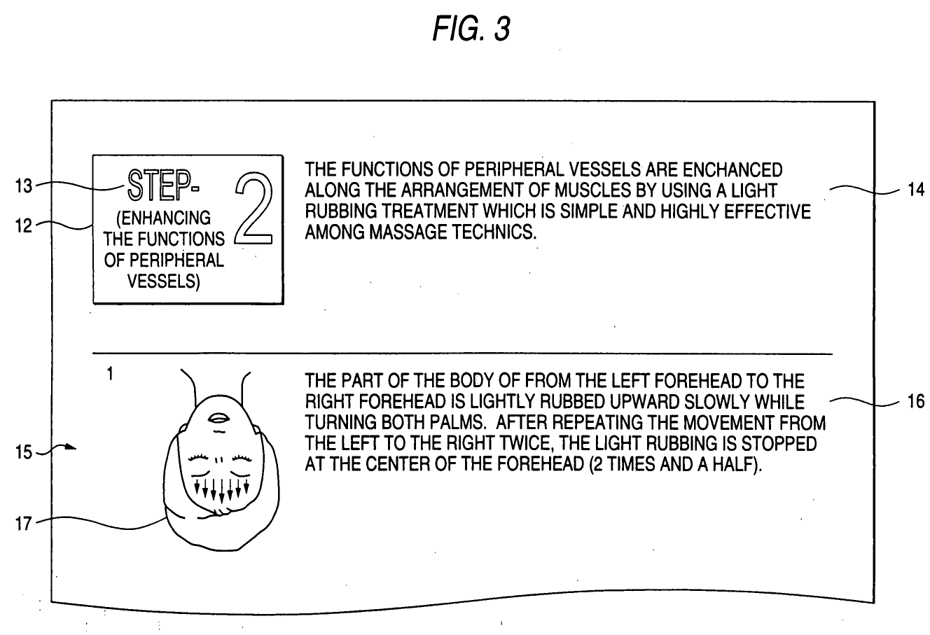

As FIG. 3 shows, a square frame 12 is provided in the left of the upper column of the next page. This frame has a title 13: “STEP-2 (Enhancing the functions of peripheral vessels.)” in it. An instruction 14 of this step: “The functions of peripheral vessels are enhanced . . . by using a light rubbing treatment which is simple and highly effective among massage technics.” is given in the right.

In 7 columns from the further lower column of this page to the next page, 7 kinds of treatments for enhancing the functions of peripheral vessels are provided with illustrations. In 15 of the column 1 (FIG. 3 (1)), for example, an instruction 16 of the treatment: “The part of the body of from the left forehead to the right forehead is lightly rubbed upward slowly while turning both palms. After repeating the movement from the left to the right twice, the light rubbing is stopped at the center of the forehead (2 times and a half).” is provided. In an illustration 17 of a woman's face provided in the left, the movements of the fingers are shown by arrows. Description on the treatments of the second column and thereafter is omitted herein.

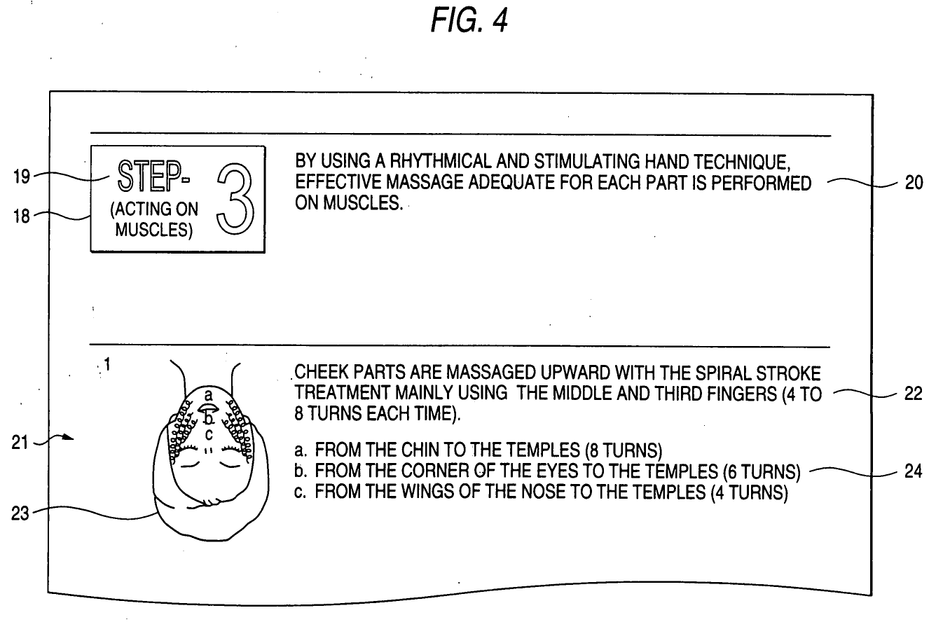

As FIG. 4 shows, a square frame 18 is provided in the left of the upper column of the next page. This frame has a title 19: “STEP-3 (Acting on muscles.)” in it. An instruction 20 of this step: “By using a rhythmical and stimulating hand technique, effective massage adequate for each part is performed on muscles.” is given in the right.

In 7 columns from the further lower column of this page to the next page, 7 kinds of treatments for acting on muscles are provided with illustrations. In 21 of the column 1 (FIG. 4 (1)), for example, an instruction 22 of the treatment: “The cheek parts are massaged upward with the spiral strokes treatment mainly using the middle and third fingers (4 to 8 turns each time).” is provided. In an illustration 23 of a woman's face provided in the left, the movements of the fingers are shown by 3 spiral-shaped arrows (a), (b) and (c). Below the instruction 22, further instructions 24: “(a) From the chin to the temples (8 turns). (b) From the corner of the eyes to

the temples (6 turns). (c) From the wings of the nose to the temples (4 turns).” are provided. Description on the treatments of the second column and thereafter is omitted herein.

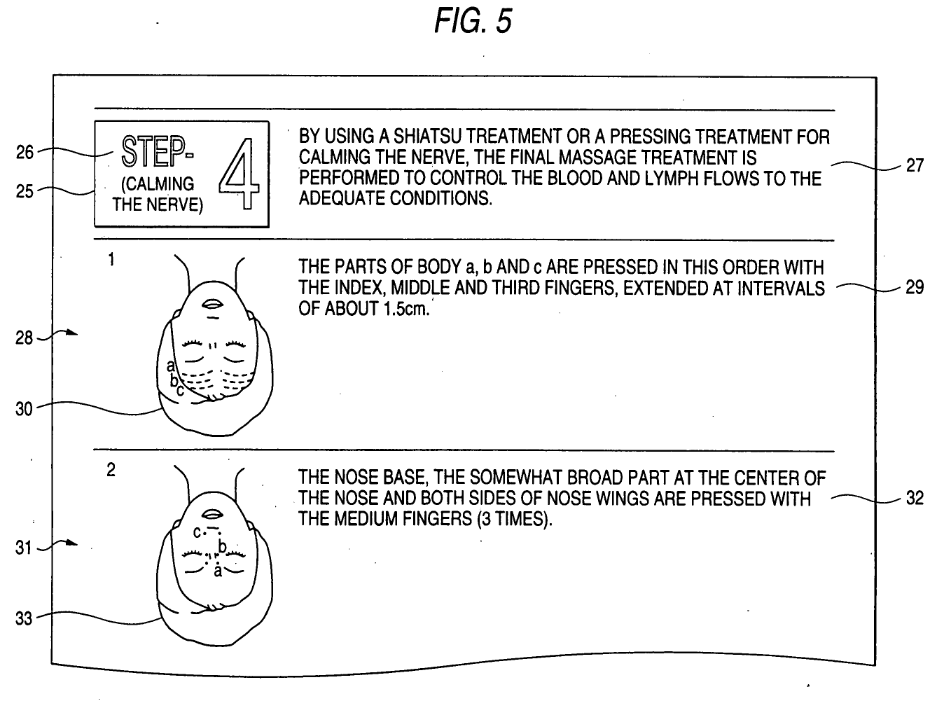

As FIG. 5 shows, a square frame 25 is provided in the left of the upper column of the next page. This frame has a title 26: “STEP-4 (Calming the nerve.)” in it. An instruction 27 of this step: “By using a shiatsu treatment or a pressing treatment for calming the nerve, the final massage treatment is performed to control the blood and lymph flows to the adequate conditions given in the right.

In 7 columns from the further lower column of this page to the next page, 7 kinds of treatments for calming the nerve are provided with illustrations. In 28 of the column 1 (FIG. 5 (1)), for example, an instruction 29 of the treatment: “The parts of body (a), (b) and (c) are pressed in this order with the index, middle and third fingers, extended at intervals of about 1.5 cm.” is provided. In an illustration 30 of a woman's face provided in the left, 3 broken lines (a), (b) and (c) connecting the pressing points are indicated.

In 31 of the lower column 2 (indicated as (2)), an instruction 32: “The nose base, the somewhat broad part at the center of the nose and both sides of nose wings are pressed with the medium fingers (3 times).” is provided. An illustration 33 in the left indicates the pressing points (a), (b) and (c). Description on the treatments of the third column and thereafter is omitted herein.

The steps 1 to 4 as described above indicate a series of treatment of the “balancing massage” (massage process).

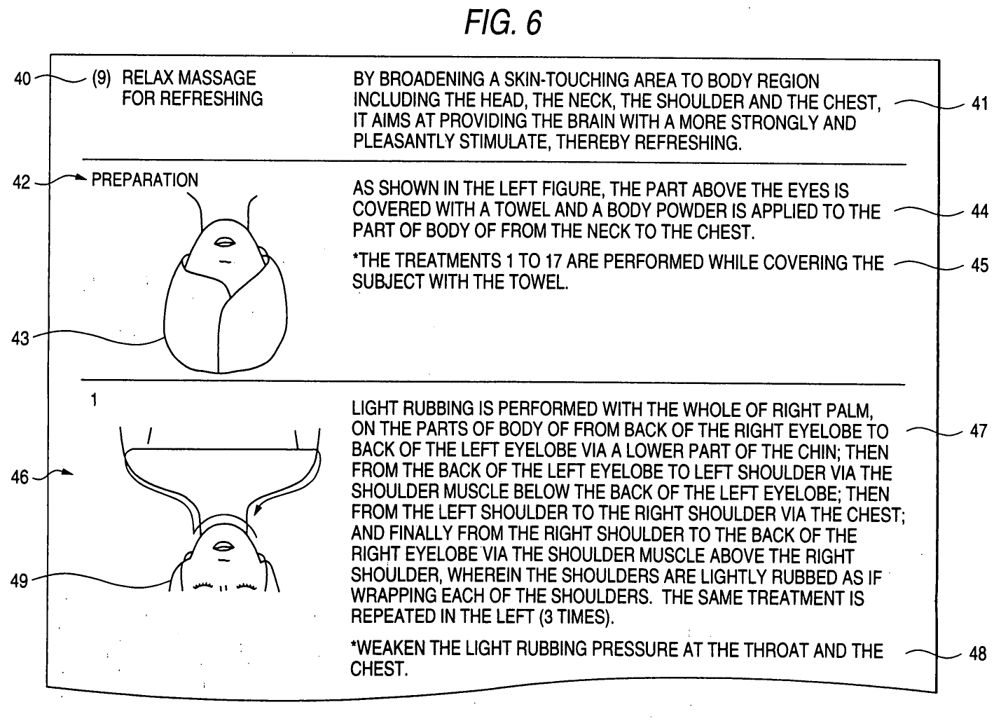

The subsequent several pages indicate “relaxing massage”, which is further effective when performed after the “balancing massage”, with illustrations as the progress of the massage process. As FIG. 6 shows, the first page has a title 40: “(9) Relax Massage—For refreshing” in the upper column, together with an instruction 41 showing the purpose of the massage: “By broadening a skin-touching area to body region including the head, the neck, the shoulder and the chest, it aims at providing the brain with a more strongly and pleasantly stimulate, thereby refreshing.”

In the lower column, a title 42: “Preparation” is given in the left and an illustration 43 of a woman's face and neck covered with a towel in the part above the eyes is indicated below it. An instruction 44: “As shown in the left figure, the part above the eyes is covered with a towel and a body powder is applied to the part of body of from the neck to the chest.” is given in the right. A note 45: “*The treatments 1 to 17 are performed while covering the client with the towel.” is given below it. Thus, it can be understood that the “relax massage” described hereinafter is performed under the conditions that a towel is placed on the part above the eyes of the client and a body powder is applied to the part of the body of from the neck to the chest.

In 46 of the lower column 1 (indicated as (1)), an instruction 47 of the treatment: “Light rubbing is performed with the whole of right palm, on the parts of body of from back of the right earlobe to the back of the left earlobe via a lower part of the chin; then from the back of the left earlobe to left shoulder via the shoulder muscle below the back of the left earlobe; then from the left shoulder to the right shoulder via the chest; and finally from the right shoulder to the back of the right earlobe via the shoulder muscle above the right shoulder, wherein the shoulders are lightly rubbed as if wrapping each of the shoulders. The same treatment is repeated in the left (3 times).” is provided. A note 48: “*Weaken the light rubbing pressure at the throat and the chest.” is added below it. An illustration 49 of the part above the chest of a woman is given in the left and arrows showing the movement of hands in the above treatment are shown in the illustration.

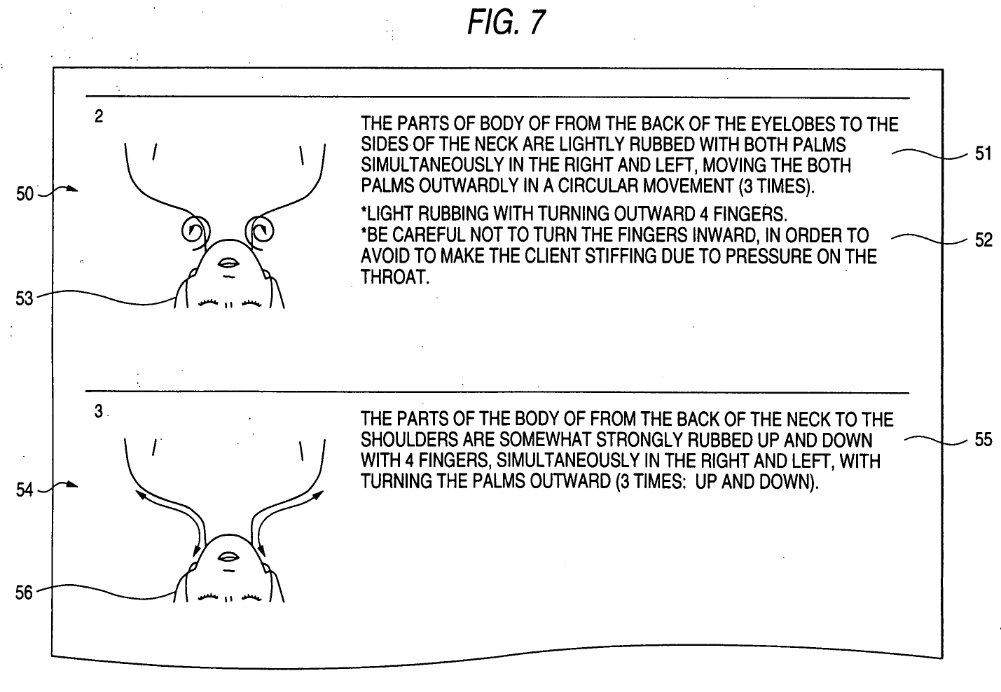

As FIG. 7 shows, in 50 of the lower column 2 (indicated as (2)), an instruction 51 of the treatment: “The parts of body of from the back of the earlobes to the sides of the neck are lightly rubbed with both palms simultaneously in the right and left, moving the both palms outwardly in a circular movement (3 times).” is provided. Below it, a note 52: “*Light rubbing with turning outward 4 fingers. *Be careful not to turn the fingers inward, in order to avoid to make the client stiffing due to pressure on the throat.” is given. In an illustration 53 of a woman given in the left, arrows showing the movement of hands are provided as in 46 of the column 1.

In 54 of the lower column 3 (indicated as (3)), an instruction 55 of the treatment: “The parts of the body of from the back of the neck to the shoulders are somewhat strongly rubbed up and down with 4 fingers, simultaneously in the right and left, with turning the palms outward (3 times: up and down)).” is provided. In an illustration 56 of a woman provided in the left, arrows showing the movement of hands are given.

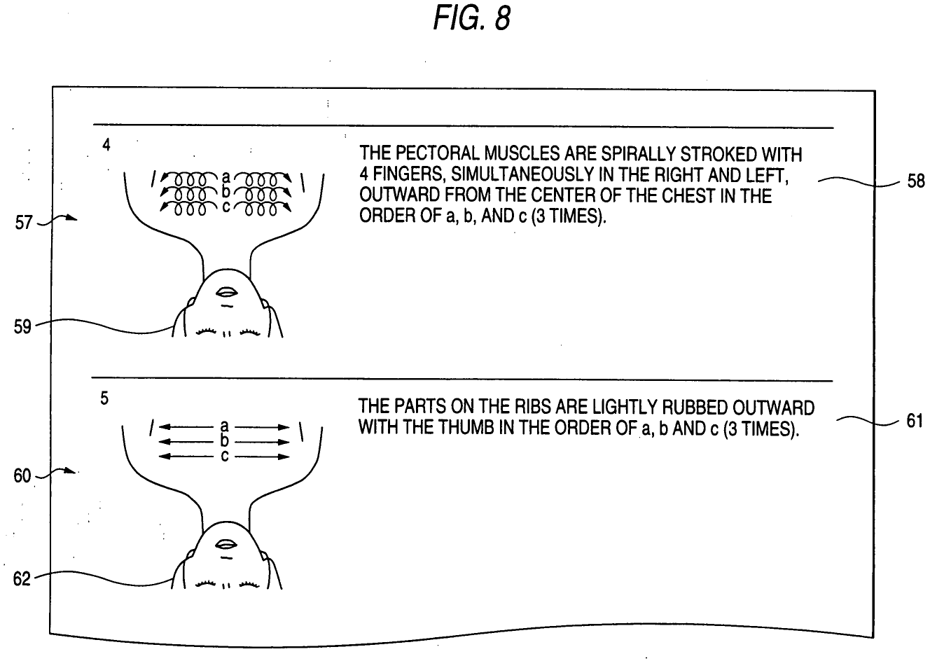

As FIG. 8 shows, in 57 of the uppermost column 4 (indicated as (4)) of the next page, an instruction 58 of the treatment: “The pectoral muscles are spirally stroked with 4 fingers, simultaneously in the right and left, outward from the center of the chest in the order of (a), (b) and (c) (3 times).” is provided. In an illustration 59 of a woman provided in the left, arrows (a), (b) and (c) showing the movement of hands are given.

In 60 of the lower column 5 (indicated as (5)), an instruction 61 of the treatment: “The parts on the ribs are lightly rubbed outward with the thumb in the order of (a), (b) and (c) (3 times).” is provided. In an illustration 62 of a woman provided in the left, arrows (a), (b) and (c) showing the movement of the hands are given.

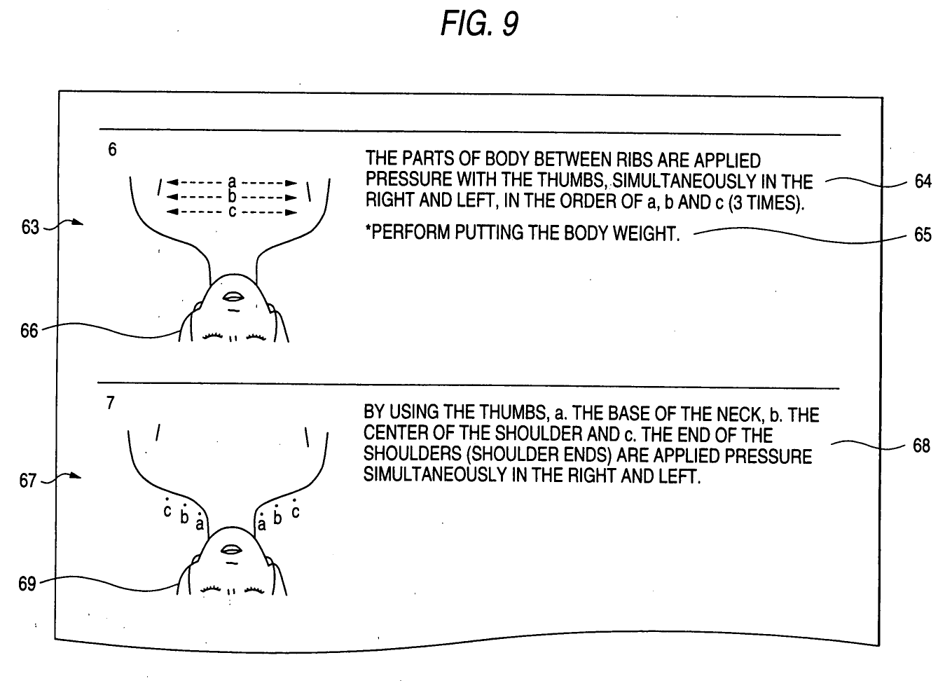

As FIG. 9 shows, in 63 of the lower column 6 (indicated as (6)), an instruction 64 of the treatment: “The parts of body between ribs are applied pressure with the thumbs, simultaneously in the right and left, in the order of (a), (b) and (c) (3 times).” is provided. Below this instruction, a note 65: “*Perform putting the body weight.” is added. In an illustration 66 of a woman provided in the left, broken lines (a), (b) and (c) connecting the shiatsu points are indicated.

In 67 of the lower column 7 (indicated as (7)), an instruction 68 of the treatment: “By using the thumbs, (a) the base of the neck, (b) the center of the shoulder and (c) the ends of the shoulders (shoulder ends) are applied pressure simultaneously in the right and left.” is provided. In an illustration 69 of a woman provided in the left, shiatsu points (a), (b) and (c) are given.

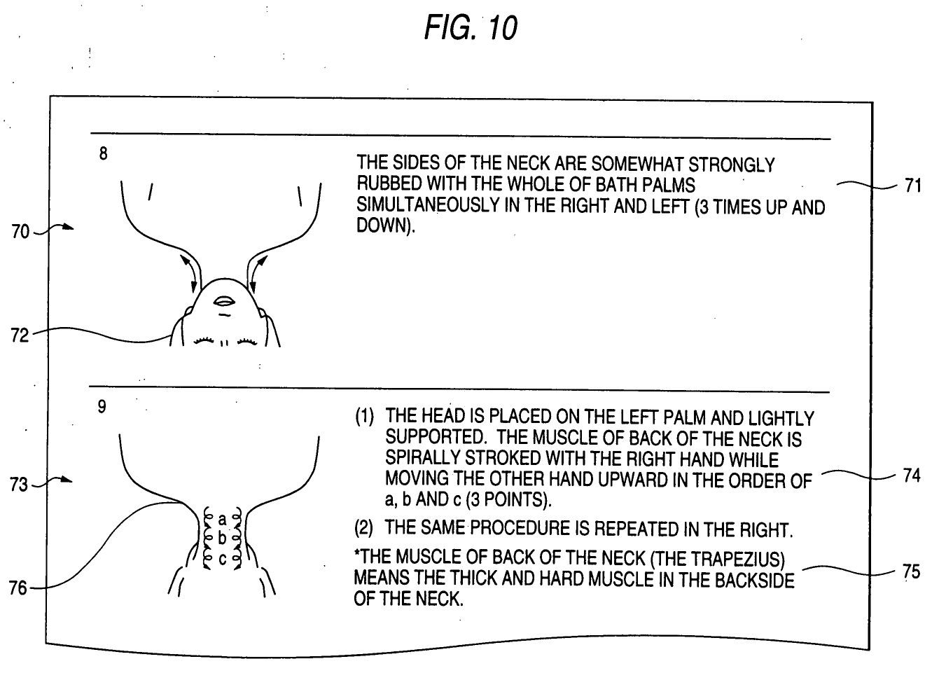

As FIG. 10 shows, in 70 of the uppermost column 8 (indicated as (8)) of the next page, an instruction 71 of the treatment: “The sides of the neck are somewhat strongly rubbed with the whole of bath palms simultaneously in the right and left (3 times up and down).” is provided. In an illustration 72 of a woman provided in the left, arrows showing the movement of hands are indicated.

In 73 of the lower column 9 (indicated as (9)), an instruction 74 of the treatment: “(1) The head is placed on the left palm and lightly supported. The muscle of back of the neck is spirally stroked with the right hand while moving the other hand upward in the order of (a), (b) and (c) (3 points). (2) The same procedure is repeated in the right.” is provided. Below this instruction, a note 75: “*The muscle of back of the neck (the trapezius) means the thick and hard muscle in the backside of the neck.” is provided. In an illustration 76 of a woman provided in the left, arrows showing the movement of hands (a), (b) and (c) are given.

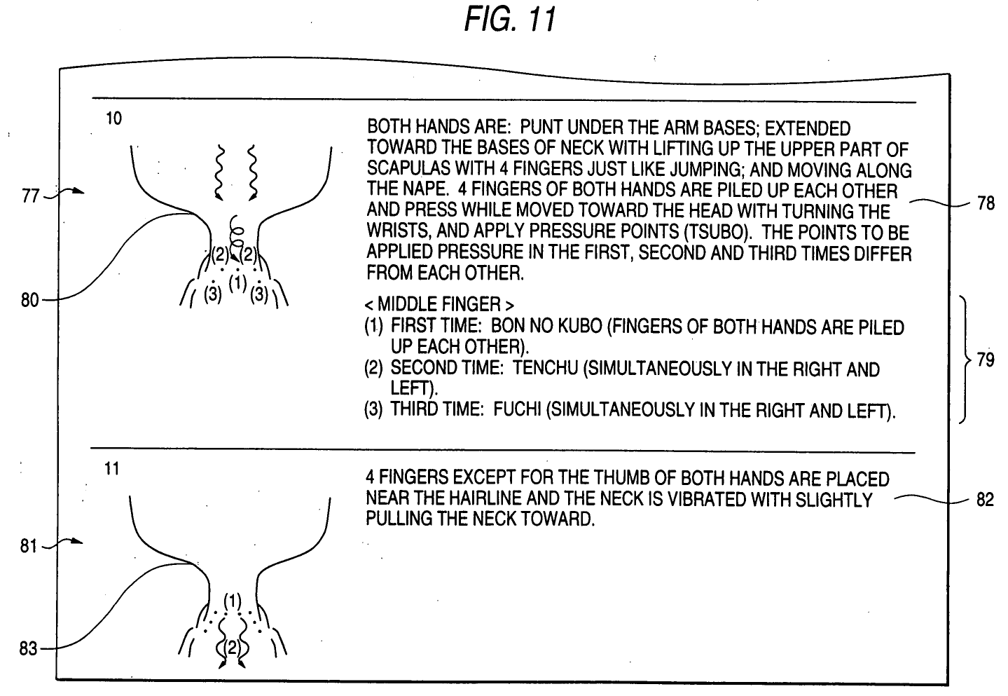

As FIG. 11 shows, in 77 of the lower column 10 (indicated as (10)), an instruction 78 of the treatment: “Both hands are: put under the arm bases; extended toward the bases of the neck with lifting up the upper part of scapulas with 4 fingers just like jumping; and moved along the nape. 4 fingers of both hands are piled up each other and press while moved toward the head with turning the wrists, and apply pressure points (tubo). The pressure points to be applied pressure in the first, second and third times differ from each other.” is provided. Below this instruction, a supplementary instruction 79 of the treatment: “<Middle finger>(1) First time: bonnokubo (fingers of both hands are piled up each other). (2) Second time: tenchu (simultaneously in the right and left). (3) Third time: fuchi (simultaneously in the right and left).” is provided. In an illustration 80 of a woman provided in the left, arrows showing the movement of hands and the points (1) to (3) are indicated.

In 81 of the lower column 11 (indicated as (11)), an instruction 82 of the treatment: “4 fingers except for the thumb of both hands are placed near the hairline and the neck is vibrated with slightly pulling the neck toward.” is provided. In an illustration 83 of a woman provided in the left, the position of the fingers (1) and the movement of the neck (2) are indicated.

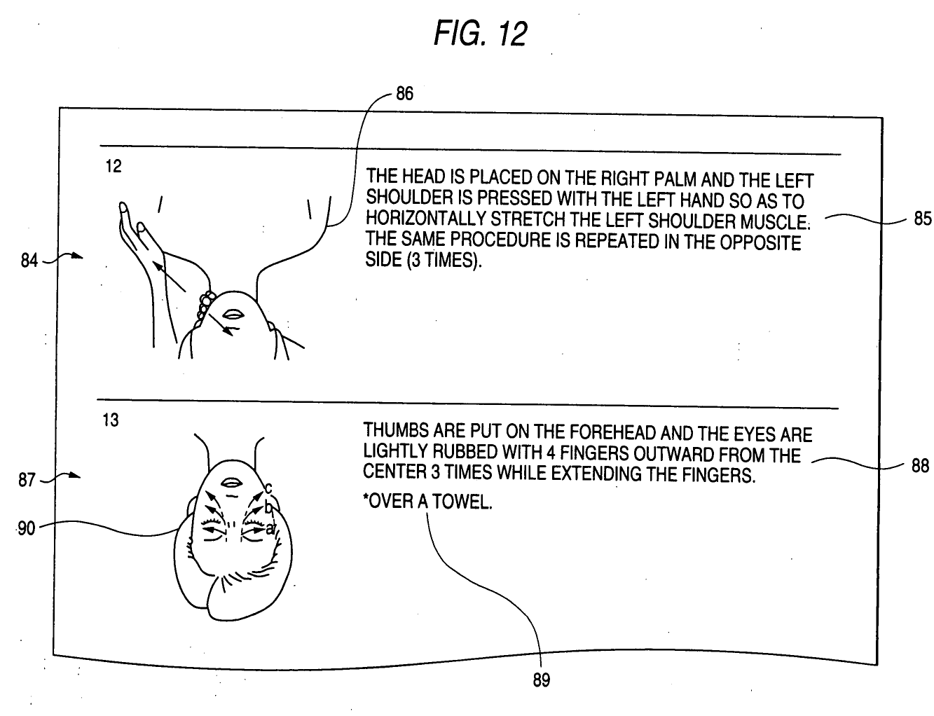

As FIG. 12 shows, in 84 of the uppermost column 12 (indicated as (12)) of the next page, an instruction 85 of the treatment: “The head is placed on the right palm and the left shoulder is pressed with the left hand so as to horizontally stretch the left shoulder muscle. The same procedure is repeated in the opposite side (3 times).” is provided. In an illustration 86 of a woman provided in the left, an arrow showing the movement of the hand is indicated.

In 87 of the lower column 13 (indicated as (13)), an instruction 88 of the treatment: “Thumbs are put on the forehead and the eyes are lightly rubbed with 4 fingers outward from the center 3 times while extending the fingers. Below this instruction, a note 89: “*Over a towel.” is provided. In an illustration 90 of a woman provided in the left, arrows showing the movement of hands (a), (b) and (c) are given.

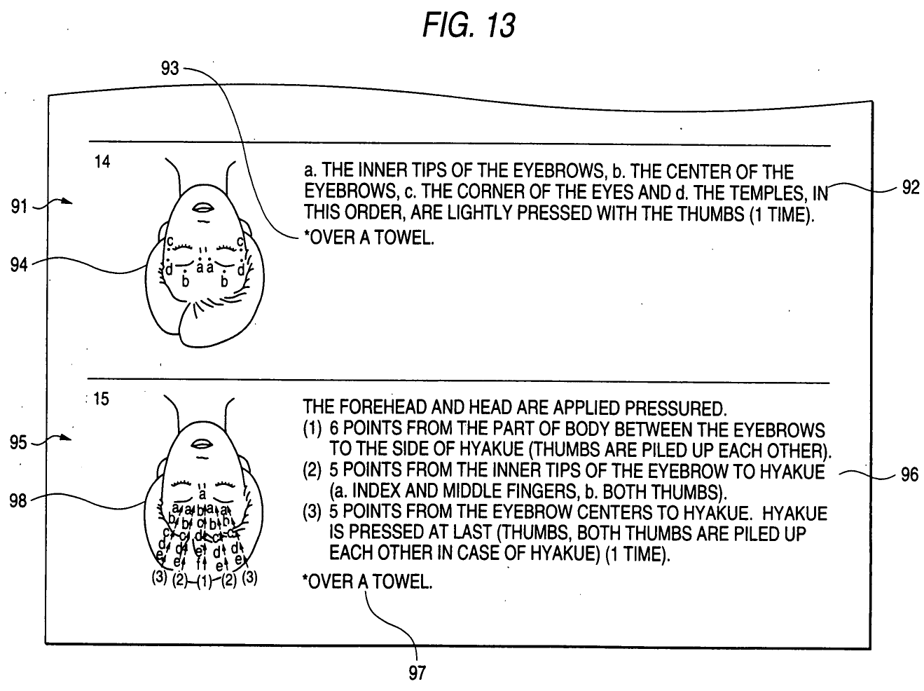

As FIG. 13 shows, in 91 of the lower column 14 (indicated as (14)), an instruction 92 of the treatment “(a) The inner tips of the eyebrows, (b) the center of the eyebrows, (c) the corner of the eyes and (d) the temples, in this order, are lightly pressed with the thumbs (1 time).” is provided. Below this instruction, a note 93: “*Over a towel.” is provided. In an illustration 94 of a woman provided in the left, the points (a) to (d) to be pressed with hands are indicated.

In 95 of the lower column 15 (indicated as (15)), an instruction 96 of the treatment: “The forehead and head are applied pressure. (1) 6 points from the part of body between the eyebrows to the side of hyakue (thumbs are piled up each other.) (2) 5 points from the inner tips of the eyebrows to hyakue (a. index and middle fingers, b. both thumbs). (3) 5 points from the eyebrow centers to hyakue. Hyakue is pressed at last (thumbs, both thumbs are piled up each other in case of hyakue) (1 time).” is provided. Below this instruction, a note 97 “*Over a towel.” is provided. In an illustration 98 of a woman provided in the left, the points (a) to (f) to be applied pressure with hands and the order (1) to (3) are indicated.

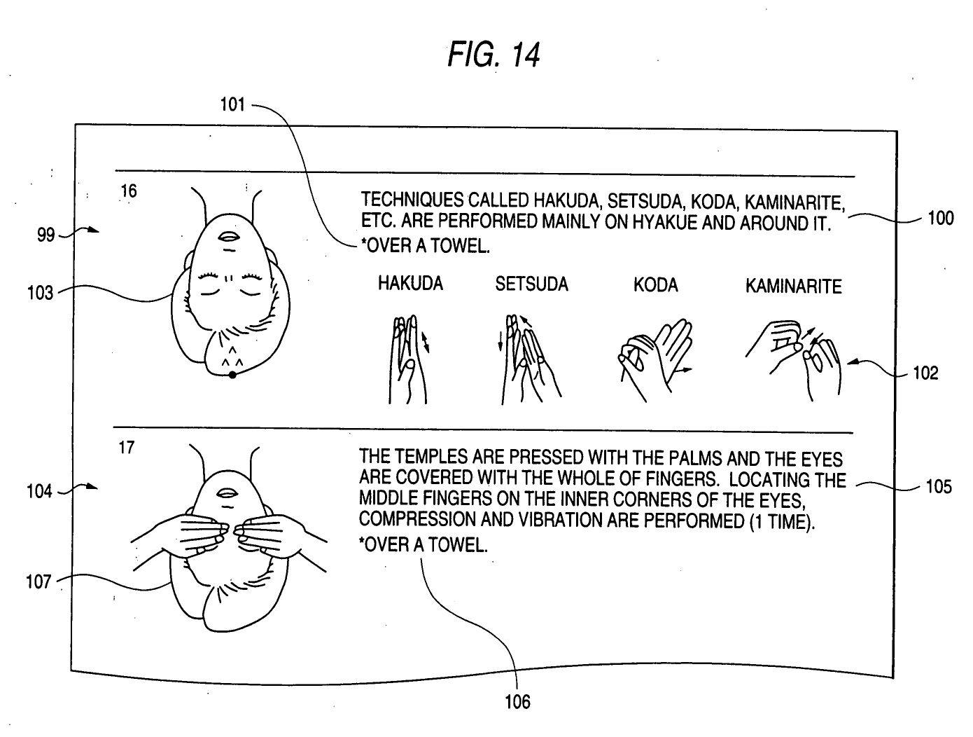

As FIG. 14 shows, in 99 of the uppermost column 16 (indicated as (16)) of the next page, an instruction 100 of the treatment: “Techniques called hakuda, setsuda, koda, kaminarite, etc. are performed mainly on hyakue and around it.” is provided. Below this instruction, a note 101: “*Over a towel.” is added. Further, the techniques hakuda, setsuda, koda and kaminarite are illustrated as 102 below. In an illustration 103 of a woman in the left, the positions on which these techniques are carried out and the position of hyakue, are indicated.

In 104 of the lower column 17 (indicated as (17)), an instruction 105 of the treatment: “The temples are pressed with the palms and the eyes are covered with the whole of fingers. Locating the middle fingers on the inner corners of the eyes, compression and vibration are performed (1 time).” is provided. Below this instruction, a note 106: “*Over a towel.” is added. In an illustration 107 of a woman provided in the left, the movements of hands are indicated.

In accordance with the contents of the pamphlet 1 constructed as described above, estheticians, etc. can perform the balancing massage on the face of a client and then the relax massage on the head, the neck, the shoulder and the chest. By massaging in 2 steps as described above, the blood flow and lymph balance of the face are first well controlled by the balancing massage on the face and then mental and physical stresses are relieved by the relax massage on the chest and above. As a result, both of the blood and lymph smoothly flow from the heart to the face. Owing to the synergistic effects of these massage processes, excellent beauty effects, which cannot be established by the conventional methods, can be achieved.

In the above-described example, in particular, the relax massage is carried out after applying a body powder to from the neck to the chest. By using a body powder having a smell effective in healing, the relaxing effect is further enhanced and more favorable results can be achieved.

Examples of the body powder having a smell effective in healing as described above include “Perfume Powder Marielle”, “Perfume Powder HINOTORI”, “Dali Mix Gold BodyPowder” and “Myuk Refresh Powder” (all manufactured by Kanebo, Ltd.).

The facial massage, which is to be performed prior to the relax massage as described above, is not restricted to the balancing massage as shown in this example but may have an arbitrary constitution. However, it is appropriate to use a massage method mainly aiming at promoting the blood flow and the lymph flow as the above-described balancing massage.

In the above-described example, the relax massage includes 17 treatments. However, the contents of the relax massage are not particularly restricted, so long as the relax massage is performed on the chest and the above, and both of the body and the mind can be relaxed thereby. To achieve a relaxing effect, it is preferable to use a combination of at least 2 of the 17 treatments for treatment as described above. In these 17 treatments, moreover, the movements of fingers and the number of repeating movement may be somewhat altered.

In the above example, the data concerning the beauty treatments are summarized in the pamphlet 1 so that manipulators can perform the treatment by reference to the pamphlet. However, it is not always necessary to use such a printed matter. Namely, use can be also made of image devices such as TV monitors, CRTs and liquid crystal monitors or computers. Needless to say, manipulators can perform the treatment without resort to any indications.

In the beauty treatment methods according to the invention, as described above, the blood flow and the lymph balance of the face are first well controlled by the beauty treatment on the face and then mental and physical stresses are relieved by the specific relaxing massage on the chest and above. As a result, both of the blood and the lymph smoothly flow from the heart to the face. Owing to the synergistic effects of these massage treatment, excellent beauty effects, which cannot be established by the conventional methods, can be achieved.

1-5. (canceled)

6. A beauty treatment method comprising:
performing a beauty treatment on the face of a client, wherein the beauty treatment includes performing a first massage process; and
performing a relaxing massage on at least one body part selected from the group consisting of the head, the neck, the shoulder and the chest of the client, wherein the relaxing massage includes performing a second massage process,
wherein the first massage process and the second massage process differ, wherein the relaxing massage further includes applying a body powder to the part of body of from the neck to the chest of the client, and wherein the body powder has a perfume smell.

7. The beauty treatment method as claimed in claim 6, wherein the second massage process includes performing at least two treatments selected from the group consisting of treatments (1) to (17):
(1) a first light rubbing treatment which is performed with the whole of one palm, alternatively in the right and left of the client, on the following parts of body of the client: from back of one earlobe to back of the other earlobe via a lower part of the chin; then from the back of the other earlobe to one shoulder via the shoulder muscle below the back of the other earlobe; then from the one shoulder to the other shoulder via the chest; and finally from the other shoulder to the back of the one earlobe via the shoulder muscle above the other shoulder, wherein the shoulders are lightly rubbed as if wrapping each of the shoulders;
(2) a second light rubbing treatment which is performed with the whole of both palms, simultaneously in the right and left of the client, on the parts of body of from the back of the earlobes to the sides of neck of the client, moving the whole of both palms outwardly in a circular movement;
(3) a first rubbing treatment wherein the parts of body of from the back of the neck to the ends of the shoulders of the client is rubbed up and down with the fingertips of both hands, simultaneously in the right and left of the client;
(4) a first spiral strokes treatment, wherein the pectoral muscles of the client are spirally stroked with the fingertips of both hands, simultaneously in the right and left of the client, while moving outward from the center of the chest;
(5) a third light rubbing treatment, wherein the parts on the ribs of the client are lightly rubbed with thumbs of both hands, simultaneously in the right and left of the client, while moving outward from the center of the chest;
(6) a first shiatsu treatment, wherein the parts of body between ribs of the client are applied pressure with thumbs of both hands, simultaneously in the right and left of the client, while moving outward from the center of the chest;
(7) a second shiatsu treatment, wherein the bases of the neck, the center of the shoulders and the ends of the shoulders of the client, in this order, are applied pressure with thumbs of both hands, simultaneously in the right and left of the client;
(8) a second rubbing treatment, wherein the sides of the neck of the client are rubbed up and down with both palms, simultaneously in the right and left of the client;
(9) a second spiral strokes treatment, wherein the head of the client is supported with one palm and a muscle in the back of the neck of the client is spirally stroked with the other hand while moving the other hand upward, alternatively in the right and left of the client;
(10) a pressing treatment, wherein both hands are: put under the arm bases of the client; extended toward the bases of the neck of the client while lifting up the upper part of scapulas of the client; and moved along the nape of the client, and then press the parts of body of from the neck to the back of the head of the client while turning the wrists crossed together;
(11) a vibrating treatment, wherein both hands are placed near the hairline of the client and the neck of the client is vibrated with the both hands while slightly pulling the neck of the client toward;
(12) a stretching treatment, wherein the head of the client is placed on one palm, and the shoulder of the client on which the fingers of the palm are placed is pressed with the other hand so that the shoulder muscle of the client is stretched in horizontal direction, alternatively in the right and left of the client;
(13) a fourth light rubbing treatment, wherein both thumbs are placed on the forehead of the client and the parts above the eyes of the client are lightly rubbed with four fingers of each hand, simultaneously in the right and left of the client, while extending the four fingers outward from the center of the face of the client;
(14) a third shiatsu treatment, wherein the inner tips of the eyebrows, center of the eyebrows and the temples of the client are applied pressure in this order with both thumbs simultaneously in the right and left of the client;
(15) a fourth shiatsu treatment, wherein the fingertips of both hands are moved while applying pressure from the forehead to the back of the head of the client, simultaneously in the right and left of the client;
(16) a tapping treatment, wherein the top of the head of the client is continuously tapped with both hands; and
(17) a pressing and vibrating treatment wherein the parts of from the temples to the inner corners of the eyes of the client are covered with both palms, and are pressed and vibrated simultaneously in the right and left of the client.

8. The beauty treatment method as claimed in claim 6, wherein at least one of the first massage process and the second massage process is performed using a body part of a person performing the treatment.

9. The beauty treatment method as claimed in claim 8, wherein the body part of a person performing the treatment includes at least one of hands.
